(19) United States
(12) Patent Application Publication
(10) Pub. No.: US 2003/0070604 A1
(43) Pub. Date: Apr. 17, 2003

(54) Test system and method for producing a test signal for food tolerance analysis

(75) Inventors: Klaus-Dieter Holzrichter, Bocholt (DE); Dieter Jossner, Reinau (DE)

Correspondence Address: NIXON PEABODY, LLP, 8180 GREENSBORO DRIVE, SUITE 800, MCLEAN, VA, 22102, US

(73) Assignee: HoriSan GmbH, Bocholt (DE)

(21) Appl. No.: 10/235,840

(22) Filed: Sep. 6, 2002

(30) Foreign Application Priority Data
Sep. 6, 2001 (DE) 101 43 853.2
Sep. 13, 2001 (DE) 101 45 249.7

(51) Int. Cl. G01D 3/00

(52) U.S. Cl. 116/200; 600/300

(57) ABSTRACT

A test system and a method for producing a test signal for food tolerance analysis using a signal producing device (12), from which an electric signal may be produced at a defined frequency spectrum and may be electrically coupled with a sample (18) containing at least one sample substance, and with an output (23), via which the signal generated by the signal producing device (12) may be emitted when coupled electrically with the sample (18). The test system and method enable food tolerance analysis to be performed easily, safely and quickly.

### BACKGROUND OF THE INVENTION

1. Field of the Invention

The invention concerns a test system and a method for producing a test signal for a food tolerance analysis.

2. Description of Related Art

The purpose of food tolerance analyses is to find individualized nutrition for any individual. The composition of food relative to the selection of individual foods and the composition percentage, namely, the rate of fat, carbohydrates, and protein, must be oriented to the function of the metabolism, and therefore, the processing of the supplied food to build energy. If a person consumes food, which their metabolism cannot currently process, appropriate health problems will occur.

Based on research by Professor Schole, or his three-component theory to be precise, and on the observations of various authors in the United States, the function of the metabolism represents a very unstable balance and depends on various factors. This, on one side, includes the genetic, unchangeable factors, such as blood type and the relativity to one of the four “gland types.” On one hand, variable metabolism types are included in these, and on the other hand, concerning the autonomous neurological system, relative to the sympathetic type or the parasympathetic type, relative to the fast burner, the slow burner, or the balanced type.

The above-mentioned variable metabolism types are subject to a multitude of effects from the environment, such as bacteria, viruses, toxins, electrical stress, geopathic stresses, medicines, incorrect selection of nourishment, etc. In addition, the psyche is a factor that should not be ignored. This multitude of effects leads to the fact that the metabolic balance easily becomes imbalanced. Only difficult to recognize modifications in the metabolic level of the person concerned develop in such a case, which lead to the fact that now individual food components, such as carbohydrates, proteins and/or fat are process and tolerated differently than before. So-called sensitivity disturbances, such as fatigue, apathy, irritation, sleeplessness, depression and weight fluctuations therefore develop. Based on intentional incorrect nutrition, marked changes in the physical composition with the results of malnutrition and a modification of the acid-based balance develop. Additional changes develop based on the hormone level which, on one hand, further increases the metabolic imbalance and, on the other hand lead, to ravenous hunger attacks, which leads the affected person to modify their eating habits and typically to gain weight.

If such a person enters into nutritional counseling, he/she is generally told to eat 60% of carbohydrates, 25% of protein and 15% of fat according to current applicable concepts. However, other forms of nutrition are also recommended, such as a vegetarian diet, macro-biotics, unprocessed foods diet, etc. All of these recommendations of nutrition represent totally sensible nutrition for one or the other metabolic type, however, this is not for everyone. A standard nutritional recommendation, which in no way is oriented toward the current metabolic situation of the person concerned, generally represents a long odyssey from diet to diet for the person concerned.

It is the contribution of Dr. Kelly and Dr. Wolcott to increase knowledge of the various metabolic types over the past thirty years. Clear recommendation in reference to selection and composition of food may now be made for the individual metabolic types. If a person eats according to their current metabolic type, clear improvements in their well-being occur in a short time and laboratory-produced chemical modifications in the sense of an improvement in the values result. Excess-weight or under-weight will normalize, and the person will maintain their weight, as long as they stay within the recommendation for the appropriate metabolic type.

However, since the metabolic type can change again, it will be sensible to check the metabolic type more frequently. An examination every six to twelve months is generally sufficient for a healthy person. Persons with health problems or weight problems should receive examinations every four to six weeks.

Dr. Kelly and Dr. Wolcott define the metabolic type from a combination of approximately 250 multiple choice questions and very expansive laboratory conducted chemical analyses. The time required per patient is several hours to days, so that the determination is very expensive. This system of metabolism type identification is not more readily available based on that reason.

Furthermore, a kinesiological muscle test, during which food, possibly in neutral containers, is held to the chest of the test person, in order to test their reaction, is also familiar in the food tolerance analysis. The problem therein exists, though, that these methods require too much time and alternating effects with other foods, which the test person has consumed, cannot be excluded.

### SUMMARY OF THE INVENTION

Therefore, it is a primary object of the present invention to make a test system and/or a method available with which the individual and optimal nutrition, the relativity to any metabolic types, the relativity to a “gland type” and suitable nutritional products may be determined by a simple and safe manner in a brief period of time, in order to finally improve the nutritional situation of the person.

The previously described and explained problem is solved by the invention by a test system to produce a test signal for a food tolerance analysis using a signal producing device, from which an electric signal may be produced at a defined frequency spectrum and may be electrically coupled with a sample containing at least one sample substance, and with an outlet, via which the signal produced by the signal producing device may be emitted when coupled electrically with the sample.

The signal originally produced by the signal producing device, electrically coupled with the sample, and sent via the outlet of the test system, according to the invented test system, also designates the test signal. Therefore, the test signal is such a signal, which is influenced by a sample substance containing sample via the electrical coupling. Even if occasionally it is difficult to prove in testing that the signal originally produced by the signal producing device has been at least been influenced and/or modified to such an extent by the electrical coupling with the sample, it is recognizably based on physical reactions of the tested person. When separating the electrical coupling between the sample and the signal producing device, the reaction produced with the available electrical coupling in the tested persons fails to materialize. Extensive studies of the claimant, within which a number of persons have been tested using the invented system, show this.

Based on the invented test system, a food tolerance analysis, which is based on the research results of Professor Schole and Professor Lutz (“three component theory” of 1982), becomes thereby available. Professor Schole was able to show, that the human organism reacts to external test signals. This principle is utilized by the invented test system. Relative to the type of sample substance, more or less intensive reactions develop in the body, which, for example, have been proven in test persons via a modification of the autonomous neurological system by utilizing methods of naturopathy, such as kinesiology, physio-energetics, RAC (pulse touch) bio-tensor or EAV.

It has been shown, that the best test results have been attained with the invented test system when the signal produced by the signal producing device is a broadband static signal. Generally, it is sufficient that the frequency range stretches from a few Hertz up to approximately 600 kHz. According to a preferred further development of the invention, however, it is intended that the frequency range will stretch from approximately 0.5 Hz to 100 MHz. This method will assure that practically any conceivable substance may be used as a sample.

It is basically possible to select all of those voltages, which are harmless to the health of the test person, as amplitude for the signal produced by the signal producing device. According to a preferred further development of the invention, however, it is intended that the signal produced by the signal producing device shows a maximum amplitude of below 1 V, whereby the maximum amplitude preferably is in a range between 200 to 300 mV.

It is basically also possible, that the signal produced by the signal producing device is supplied to the test person as continuous signal. According to a preferred further development of the invention, however, it is intended that the signal emitted via the outlet may be pulsated using a pulsating device. It has been specifically advantageous if the pulse frequency corresponds with a biologically neutral frequency and thereby preferably is within a range between 1900 and 2500 Hz and especially preferred at approximately 2000 Hz.

There are several possibilities to supply the signal emitted via the outlet of the test system to the test person. Preferred, however, is the supply via an electrical line connected to the outlet of the test system, which ends at a wrist band that is to be looped over the wrist of the test person. Within this context it is intended that the skin of the test person comes into direct contact with the test signal via the electrically conductive wrist band.

A possible application for a food tolerance analysis of the test signal produced by the test device comprises the ability to test a potential reaction development in the test person due to a specific test substance. However, in order to now also obtain a quantitative statement concerning the reaction to a specific sample substance by the test person, another preferred further development of the invention provides that the capacity of the signal emitted via the outlet is controllable. Preferentially, it is intended that the test system has a dial available, via which the capacity of the signal may be predetermined. The control of the capacity of the signal emitted via the outlet may be accomplished with the assistance of various methods. So it is possible, for example, to control the signal emitted via the outlet via the signal amplitude.

According to a preferred further development of the invention, however, it is intended that the control of the capacity of the signal emitted via the outlet occurs via a pulse width modulation. In addition, an indicator device is also provided for the capacity of the signal emitted via the outlet, whereby the indicator device in form of a percentage display, preferably from 0 to 100% in 5% increments, has been proven to be especially successful.

Various methods in reference to the electrical coupling of the sample with the signal producing device are basically also possible. According to a preferred further development of the invention, however, it has been planned that the electrical coupling of the sample with the signal producing device occurs via a dual-gate MOSFET. Such an electrical coupling is especially advantageous, when the control of the capacity occurs via the signal emitted via the outlet by using pulse width modulation. In addition, however, also as an alternative, it is intended according to a preferred further development of the invention, that an amplifier is switched between the signal producing device and the sample, and, if provided, in front of the dual-gate MOSFET. In order not to limit the utilization of the applicable sample substances, according to a preferred further development of the invention, it is planned that the amplifier is of a very wide bandwidth.

Although the test system is basically also operable using alternating current, according to a preferred further development of the invention, it is intended that the test system will be operated using direct current. This is especially advantageous insofar as no interference frequencies are thus produced, which may superpose the test signal emitted via the outlet of the test system. In order to produce direct current, especially to provide the possibility to connect the invented test system to a standard 50 Hz alternating current power supply, a power supply has been provided, which is located outside the test system according to a preferred further development of the invention. By this method, coupling the 50 Hz alternating current power supply into the test system and thereby a superposition of the 50 Hz alternating current power supply with the signal emitted via the outlet of the test system is also being prevented. In addition, a preferred further development of the invention provides that the power supply has a filter element and/or a screen element, which further reduces disturbing waves in the invented test system.

The sample may typically contain any substance as a sample substance, to which the test person has to be analyzed in reference to food tolerance. Specifically carbohydrates, proteins, fat, enzymes, etc. are under consideration as sample substances. Sample substances may be contained without thinners in the sample. According to a preferred further development of the invention, however, the sample will contain the sample substance in a high, homeopathic dilution. Water distilled several times serves thereby as preferred thinning agent. The sample may specifically also be developed from a nosode.

In order to broaden the testing possibilities with the invented test system, a multitude of samples with separate sample substances will be made available according to a preferred further development of the invention. It is basically possible to provide the samples outside the test system and to place them, for example, individually into the invented test system for testing. According to a preferred further development of the invention, however, the samples are intended to be complete inside the test system. Then, it will be possible to provide a selection possibility on the test system for the sample which is to be coupled electrically with the signal producing device that is to be tested on the test person. In this conjunction, it is advantageous to provide a display for the pre-selected sample, so that it is always identifiable which sample is currently being tested.

In providing a multitude of samples with separate sample substances, it has been planned according to a preferred further development of the invention, that more than one of these samples may be coupled electrically with the signal producing device. Complex test signals may be produced by this method, which expand the testing potential of the invented test system, specifically in view of the determination of the relativity of the test person to the metabolic types, i.e., to the “gland types”. The simultaneous electrical coupling of several samples with the signal producing device furthermore, is helpful to determine suitable food supplements, which will serve to improve the nutritional situation.

It has been deemed as advantageous to fill the sample substances into ampoules, whereby the ampoules preferably are of a metal, specifically preferred is a precious metal, such as gold. Less expensive ampoules with sufficient characteristics, for example, are made of aluminum. However, generally, glass ampoules are usable, whereby the appropriate prerequisites for electrical coupling of the sample substance filled into the ampoule with the signal producing device, have to be present. This, for example, may be an electrical conductor, which serves as a passage and is smelted into the glass ampoule. When arranging the ampoules in the invented test device, an ampoule carrier of an electrically insulated material has been provided. Teflon has been proven to be an excellent electrically insulating material as ampoule carrier.

The further above derived and described function is also solved in the invention by a method for producing a test signal for a food tolerance analysis, whereby an electrical signal is produced at a predetermined frequency spectrum from a signal producing device, the signal producing device is electrically coupled with at least one sample containing a sample substance and the signal produced by the signal producing device is emitted at the electrical coupling of the sample.

Preferred further developments of the invented methods result in an analogy of the previously described preferred further developments of the invented test system.

Individually, there is a multitude of possibilities to further expand and develop the invented test system and/or the invented method as will become apparent for the following detailed description of a preferred embodiment with reference to the accompany drawings.

### BRIEF DESCRIPTION OF THE DRAWINGS

FIG. 1 illustrates a test system according to a preferred embodiment of the invention,

FIG. 2 diagrammatically illustrates use of the test system according to the preferred design example of the invention, and

FIG. 3 is a block diagram illustrating the construction of the test system according to the preferred embodiment of the invention.

### DETAILED DESCRIPTION OF THE INVENTION

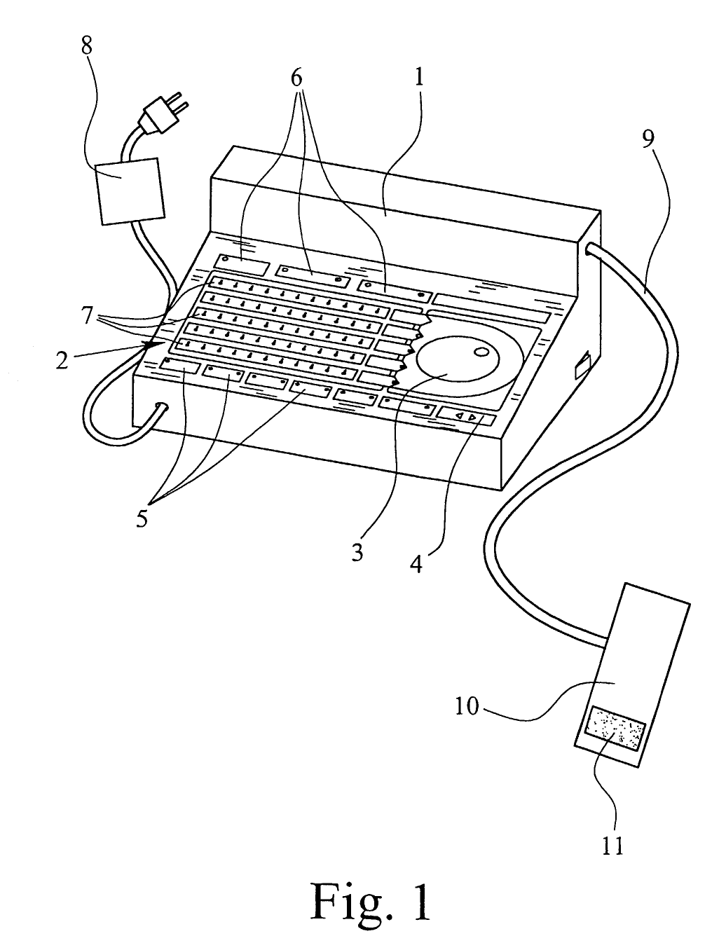

A test system to produce a test signal for a food tolerance analysis according to a preferred design example of the invention is evident in FIG. 1. The test system has a housing 1, which is provided with a control and display surface 2. On the control and display surface 2 is a dial 3 to set the capacity of the test signal. Samples located in the system, and therefore not visible in FIG. 1 may be preset individually or combined by using a selector switch 4, therefore, may be coupled electrically with the signal producing device also not visible in FIG. 1, whereby this is displayed on displays 5, 6. Relative to the selected sample or relative to the selected sample ensemble, the capacity of the test signal is displayed via a percentage display 7. In an alternative design of the test system, displays 5, 6 have separate selector switches for the individual samples.

The power for the test system is supplied by a power supply part 8, which is located outside of the housing 1 of the test system and has a filter (not shown), as well as a screen element (also not shown). By this method, or with the aid of power supply 8 located on housing 1, as well as the provision of a filter and a screen element, interference voltages, especially disturbing waves are removed from the test system, so that the test signal cannot be negatively influenced.

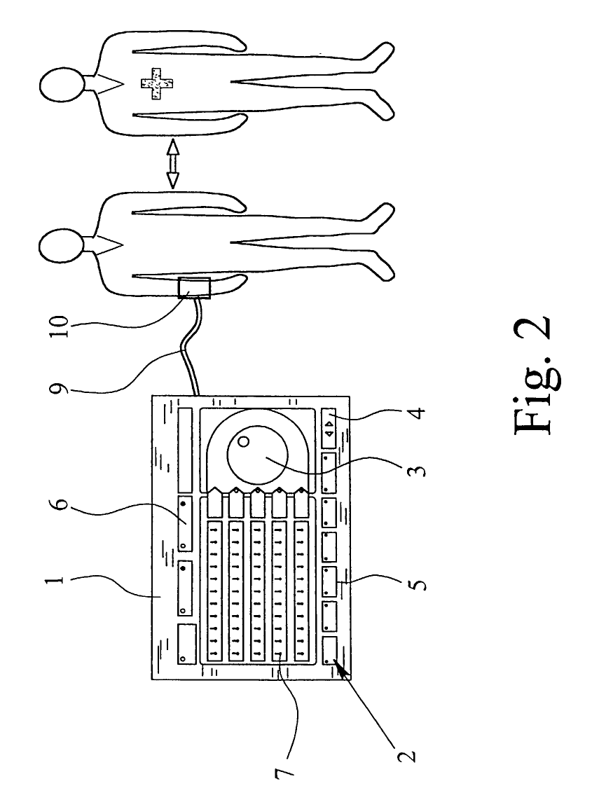

The test signal is supplied to the test person via an electrical line 9, which ends in an electrically conducting wrist band 10, which may be attached to the wrist of the test person by using a VELCRO® hook and loop type closure 11. This may be schematically viewed in FIG. 2, in which the application of the test system is schematically illustrated according to the preferred embodiment of the invention.

As previously addressed, a test signal for a food tolerance analysis is provided by the invented test system. The reaction of the person tested with this test signal, however, does not occur via the invented test system, but through methods, such as kinesiology, physio-energetics, RAC, biotensor or EAV. The recording of the physical reactions of the tested person by a performing physician or a therapist is schematically illustrated by a double arrow between the test person and the physician or therapist

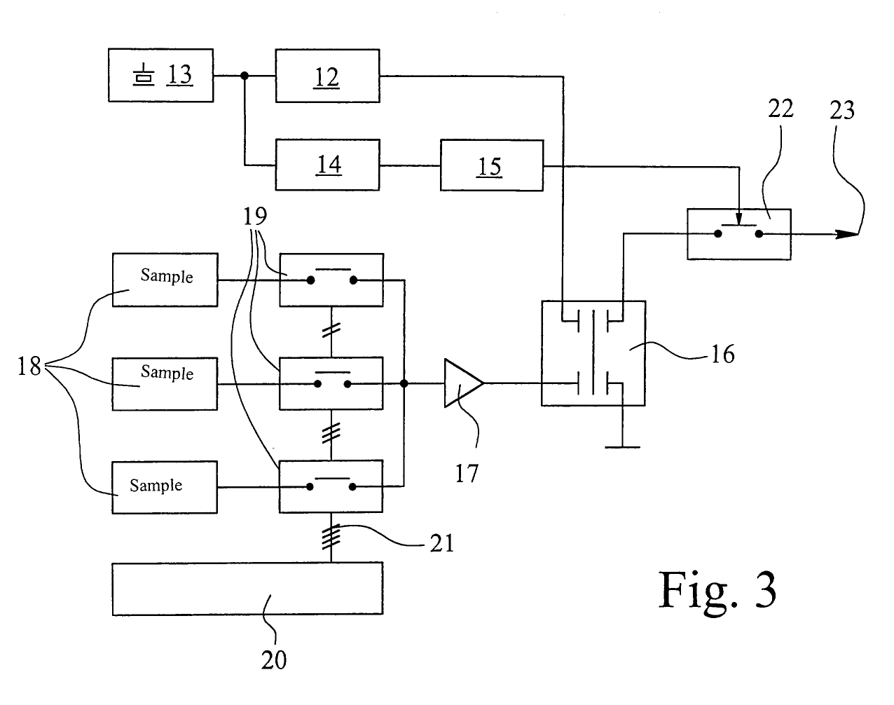

FIG. 3 finally schematically shows the design of the invented test system. A static generator, which is connected to a quartz oscillator 13, serves as a signal producing device 12. The quartz oscillator 13 is also connected with a pulse generator 14. This pulse generator 14 produces an impulse sequence with a frequency of approximately 2000 Hz. A pulse width adjustment device 15 follows the pulse generator 14, so that finally a pulse width modulated signal of a frequency of approximately 2000 Hz is emitted. This signal serves to pulsate the signal applied to the test person, as is described in detail further below.

The signal emitted by the static generator 12 is supplied to a dual-gate MOSFET 16. One or more samples 18 may be connected to the dual-gate MOSFET 16 over a broadband amplifier 17. The samples are connected via electronic switch 19, which is controlled via a selector switch 20 by a bus line 21. One or more connected samples 18 are coupled electrically with the static generator 12 via the dual-gate MOSFET 16 by this method.

The signal emitted by the dual-gate MOSFET 16, which contains the information of the static generator, as well as the information relative to the connected samples, is supplied to a signal pulse device 22, which also contain the signal coming from the pulse width device 15. A pulse width modulating test signal coming from static generator 12, is produced by this method, which contains information of at least one sample 18 on electrical coupling. FIG. 3 does not illustrate, that the pulse width modulation is externally controllable, so that the capacity of the test signal is adjustable via the pulse width modulation. The signal pulse device 22 finally leads to an outlet 23 of the test system by which the contact to the test person is produced.

As already indicated further above, the expert cannot expect or measure any influence of the broadband signal coming from the static generator 12 due to the electrically coupled samples 18, when assembling the test system according to the preferred design example of the invention. However, numerous tests show, that the reaction produced in a tested person essentially depends on whether a sample 18 is coupled electrically to static generator 12 or not, and especially also, what type of sample 18 it is, therefore, which sample substance it contains.

In conclusion, it should be pointed out that the samples 18 are available in the test system according to the preferred embodiment, in the form of aluminum tubes, in which the sample substances are located in homeopathic dilution, whereby the thinning agent is water distilled three times, which is not illustrated in FIG. 3. These aluminum tubes are also arranged in a unillustrated sample holder, which is fashioned of a Teflon block with the appropriate drill holes.

What is claimed is:

1. A test system for producing a test signal for a food tolerance analysis, comprising:
a signal producing device for producing an electric signal at a defined frequency spectrum;
a sample holder for containing at least one sample substance;
an electrically coupling for electrically coupling the signal producing device with a sample in said sample holder; and
an output via which a signal generated by the signal producing device is emitted when the signal producing device is electrically coupled with the at least one sample.

2. The test system as claimed in claim 1, wherein the signal producing device is adapted to produce a broadband static signal.

3. The test system as claimed in claim 2, wherein the broadband static signal which preferably includes a frequency range of 0.5 Hz to 100 MHz.

4. The test system as claimed in claim 1, further comprising a signal pulse generator for pulsing the signal emitted via the output.

5. The test system as claimed in claim 4, wherein the pulse generator has a pulse frequency which corresponds to a biologically neutral frequency.

6. The test system as claimed in claim 5, wherein said biologically neutral frequency is within a range between 1900 and 2050 Hz.

7. The test system as claimed in claim 5, wherein said biologically neutral frequency is approximately 2000 Hz.

8. The test system as claimed in claim 1, wherein the signal emitted via the outlet is controlled.

9. The test system as claimed in claim 8, wherein said output of the signal emitted via the output is controlled by pulse width modulation.

10. The test system as claimed in claim 1, wherein said electrically coupling comprises a dual-gate MOSFET.

11. The test system as claimed in claim 1, further comprising a broadband amplifier for switching between the signal producing device and the sample holder.

12. The test system as claimed in claim 1, wherein the test system is operable by direct current, and wherein a power supply part located outside of the test system is provided for generating the direct current.

13. A method for producing a test signal for food tolerance analysis using a signal producing device, comprising the steps of:
providing a sample holder containing at least sample substance,
electrically coupling the at least one sample with a signal producing device, and
generating an electric signal at a defined frequency spectrum with the signal producing device, the signal being emitted when the signal producing device is electrically coupled with the sample.

14. The method as claimed in claim 13, wherein the signal is by the signal producing device as a broadband static signal.

15. The method as claimed in claim 13, wherein the broadband static signal includes the frequency range of 0.5 Hz to 100 MHz.

16. The method as claimed in claim 14, wherein the signal is pulsed.

17. The method as claimed in claim 16, wherein the pulse frequency corresponds to a biologically neutral frequency.

18. The method as claimed in claim 17, wherein the biologically neutral frequency is within a range between 1900and 2050 Hz

19. The method as claimed in claim 17, wherein the biologically neutral frequency is approximately 2000 Hz.
